(19) United States
(12) Patent Application Publication
(10) Pub. No.: US 2025/0137794 A1
(43) Pub. Date: May 1, 2025

(54) BEHAVIOR SUGGESTION DEVICE AND BEHAVIOR SUGGESTION METHOD

(71) Applicant: Panasonic Automotive Systems Co., Ltd., Kanagawa (JP)

(72) Inventors: Kazuhiko YAMAUCHI, Osaka Fu (JP); Takayasu BABA, Tokyo To (JP); Kazunobu WATANABE, Kanagawa Ken (JP); Takenori MATSUMOTO, Tokyo To (JP); Kohei YAMASHITA, Osaka Fu (JP); Yoshihiro OHYA, Hyogo Ken (JP)

(73) Assignee: Panasonic Automotive Systems Co., Ltd., Kanagawa (JP)

(21) Appl. No.: 18/913,208

(22) Filed: Oct. 11, 2024

(30) Foreign Application Priority Data
Oct. 30, 2023 (JP) 2023-185263

(51) Int. Cl. G01C 21/34; H04L 67/52

(52) U.S. Cl. CPC G01C 21/3484; H04L 67/52

(57) ABSTRACT

A behavior suggestion device according to the present disclosure includes a processor and a memory having instructions that, when executed by the processor, cause the processor to perform operations. The operations include: acquiring, in communication with a first information terminal used by a first user via a network, user information of the first user received by the first information terminal, the user information including living area information indicating a living area of the first user; causing the memory to store destination candidate information including one or more destination candidates; selecting, from the destination candidate information, one or more destinations different from at least a geographical range indicated by the living area information, based on profiling information obtained by analyzing the user information of the first user; and outputting, to the first information terminal, suggestion information for suggesting the selected destination to the first user by the first information terminal.

### CROSS-REFERENCE TO RELATED APPLICATIONS

This application is based upon and claims the benefit of priority from Japanese Patent Application No. 2023-185263, filed on Oct. 30, 2023, the entire contents of which are incorporated herein by reference.

### FIELD

Embodiments described herein relate generally to a behavior suggestion device and a behavior suggestion method.

### BACKGROUND

Social problems have occurred that elderly people, who lose contact with society after mandatory retirement, stay at home, and suffer from mental and physical illness. Children of elderly people are worried about parents who stay at home, and the children have searched for methods of encouraging behavior modifications to parents such as making habits of going out or outing by car.

In the related art, as methods of promoting behavior modifications such as outing to users, methods of analyzing preferences and behaviors of the users by profiling and suggesting behaviors based on analysis results are known. The suggestion by profiling is used for recommendation of viewing contents of video-on-demand services, recommendation of products on electronic commerce (EC) sites, and the like.

For example, JP 2022-517052 A discloses contents in which an experience itinerary is generated from a preference or a user attribute (gender) and the generated experience itinerary is transmitted to a vehicle and executed.

However, even when a destination or an itinerary is suggested by profiling, there is a problem of whether elderly people or the like who tend to stay at home can accept the suggestion and make behavior modification such as going out or outing.

One of the problems to be solved according to the present disclosure is to make suggestions appropriate for users such as elderly people to make behavior modification such as going out or outing by car.

### SUMMARY

A behavior suggestion device according to an embodiment of the present disclosure includes a processor and a memory having instructions that, when executed by the processor, cause the processor to perform operations. The operations includes: acquiring, in communication with a first information terminal used by a first user via a network, user information of the first user received by the first information terminal, the user information including living area information indicating a living area of the first user; causing the memory to store destination candidate information including one or more destination candidates; electing, from the destination candidate information, one or more destinations different from at least a geographical range indicated by the living area information, based on profiling information obtained by analyzing the user information of the first user; and outputting, to the first information terminal, suggestion information for suggesting the selected destination to the first user by the first information terminal.

### BRIEF DESCRIPTION OF THE DRAWINGS

FIG. 1 is a diagram illustrating an example of a configuration of a behavior suggestion system according to an embodiment;

FIG. 2 is a diagram illustrating an example of a functional configuration of a behavior suggestion device according to the embodiment;

FIG. 3 is a diagram illustrating an example of a functional configuration of a user terminal according to the embodiment that is a main user terminal used by a user who receives a suggestion;

FIG. 4 is a diagram illustrating an example of a functional configuration of a user terminal according to the embodiment that is a support user terminal used by another user who supports the user who receives the suggestion;

FIG. 5A is a sequence chart illustrating an example of a sequence of information processing executed in the behavior suggestion system according to the embodiment;

FIG. 5B is a sequence chart illustrating an example of a sequence of the information processing executed in the behavior suggestion system according to the embodiment;

FIG. 6A is a diagram illustrating an example of a display screen of the user terminal according to the embodiment;

FIG. 6B is a diagram illustrating an example of the display screen of the user terminal according to the embodiment;

FIG. 6C is a diagram illustrating an example of the display screen of the user terminal according to the embodiment;

FIG. 6D is a diagram illustrating an example of the display screen of the user terminal according to the embodiment;

FIG. 7A is a diagram illustrating an example of a display screen of an IoT home appliance according to the embodiment;

FIG. 7B is a diagram illustrating an example of a display screen of the IoT home appliance according to the embodiment;

FIG. 8 is a flowchart illustrating an example of a flow of behavior modification determination processing of FIG. 5B that is information processing determining whether a behavior modification by the suggestion is successful;

FIG. 9 is a diagram illustrating an example of a configuration of point table information according to the embodiment;

FIG. 10 is a diagram illustrating a learning information model according to the embodiment; and

FIG. 11 is a diagram illustrating an example of a configuration of input data of the learning information model according to the embodiment.

### DETAILED DESCRIPTION

Hereinafter, embodiments of a behavior suggestion system, a behavior suggestion device, a user terminal, a behavior suggestion method, a computer program product, and a recording medium according to the present disclosure will be described with reference to the accompanying drawings.

In description of the present disclosure, components that have the same or substantially the same functions as those described earlier in the previously described drawings are denoted by the same reference numerals, and the description thereof may be appropriately omitted. In addition, even when the same or substantially the same portions are represented, dimensions and ratios may be represented differently from each other depending on the drawings. For example, from the viewpoint of ensuring visibility of the drawings, in the description of each drawing, only main components may be denoted by reference numerals, and even components that have the same or substantially the same functions as those described earlier in the previous drawings may not be denoted by reference numerals.

Hereinafter, a case in which the technique according to the present disclosure is applied to promotion of a behavior modification for outing for elderly people who tend to stay at home will be described as an example.

The technique according to the present disclosure is applicable to, for example, not only elderly people but also office employees who have nothing to do in weekends and stay at home, and people who are looking for so-called my own trend. Movable activities are targets of my own trend, and examples are activities such as collecting temple and shrine stamps, collecting castle visitor stamps, pilgrimages related to subculture, and location-based games.

In the present disclosure, an application target is an elderly person who is not active and tends to stay at home, but the technique according to the present disclosure is also applicable to a so-called active senior.

In the related art, as a technique for suggesting products or viewing content to users, techniques of profiling user's preferences, gender, or the like and suggesting products or viewing content preferred by users having similar profiling results are known, and are used in electronic commerce (EC) sites or video-on-demand services on the Internet. As an algorithm, collaborative filtering is known.

It is also conceivable to apply a machine learning technique to the suggested technique to form a learning information model in which cases of successful suggestions are accumulated as successful data and improve accuracy of the suggestion success.

However, when the users are elderly people who tend to stay at home, and suggestions are outing, the present inventors have found through research and analysis that a problem occurs that the suggestions cannot be accepted by the elderly people in the first place when the suggestions are simple destination suggestions by profiling. The term “not be accepted” as used herein means that the suggestion is not accepted or not interesting.

The suggestions are generally made by applications of smartphones or personal computers, but certain IT literacy is required for use, and there are few elderly people who have good IT literacy skills. Meanwhile, there is also a contradiction that elderly people who have good IT skills are less likely to stay at home and be socially isolated, and do not have an interest in the technique of the present disclosure.

Further, there is a problem of how much movement is determined to be successful as outing when the suggestion is accepted and the behavior modification of outing is made. When considering outing as a habit, it is not appropriate to determine a daily round trip to a nearby convenience store as outing, and when a learning information model is constructed and adjusted using daily round trips as successful data, there is a problem that accuracy of successful suggestions may be affected.

The inventors according to the present disclosure have also found a problem that it is necessary to motivate continuation such as a desire for going out again when considering habituation of outing. By solving such problems, elderly people who have good IT skills can also further enjoy outing and habituation can be expected.

An embodiment of the technique according to the present disclosure will be described below with respect to the above-described problem found by the inventors.

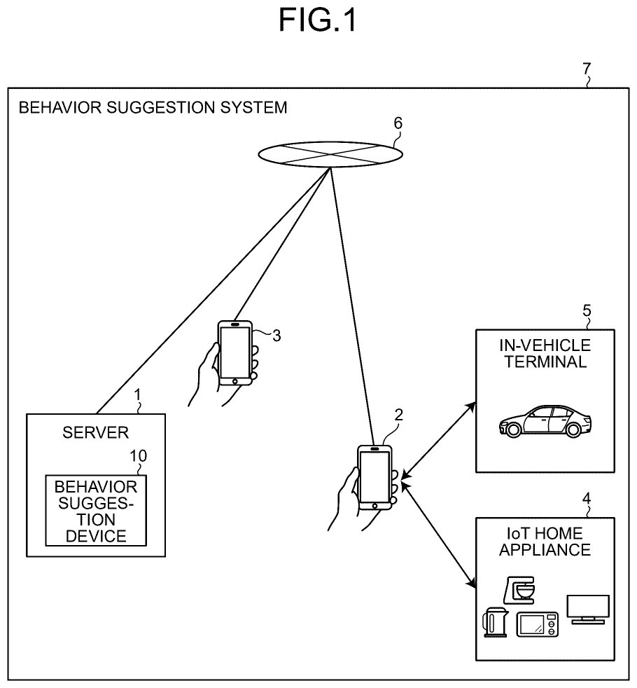

FIG. 1 is a diagram illustrating an example of a configuration of a behavior suggestion system 7 according to the embodiment. The behavior suggestion system 7 includes a server 1, at least one user terminal, and at least one network device.

FIG. 1 illustrates the behavior suggestion system 7 including a main user terminal 2 and a support user terminal 3 as the at least one user terminal. FIG. 1 illustrates the behavior suggestion system 7 including an IoT (Internet of Things) home appliance 4 and an in-vehicle terminal 5 as the at least one network device.

In the behavior suggestion system 7, the server 1 and each of the at least one user terminal are communicably connected via a network 6. As the network 6, for example, a telecommunication line such as the Internet can be used.

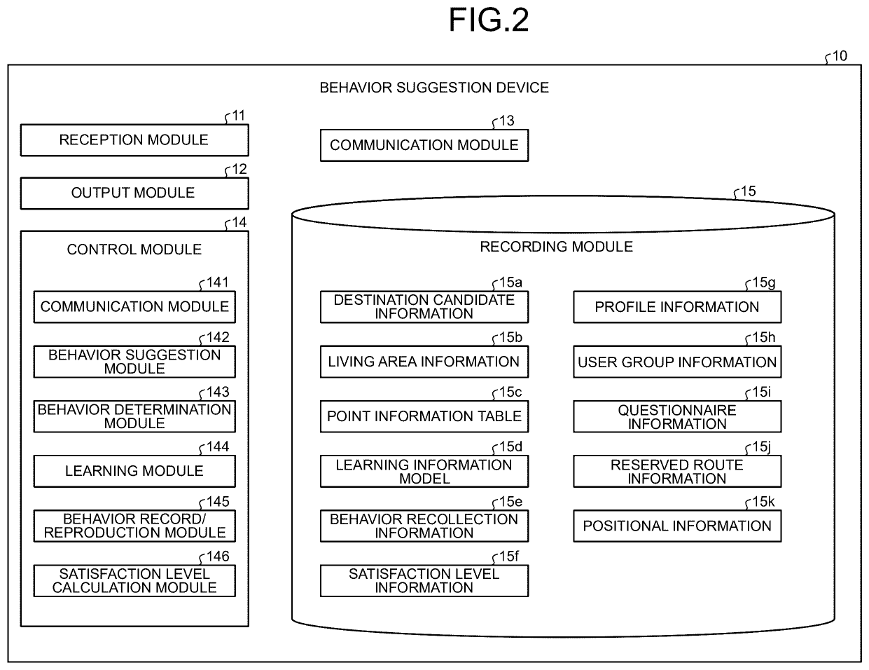

The server 1 is a device that manages the entire behavior suggestion system 7. The server 1 is realized by, for example, at least one server device provided on a cloud service. When the server 1 is realized by two or more server devices, the two or more server devices can cooperate via an application programming interface (API). In the server 1, a behavior suggestion device 10 is constructed. The behavior suggestion device 10 is a device that suggests a behavior such as going-out to a user. The behavior suggestion device 10 may be the at least one server device itself of the server 1 or may be a virtual device realized by the at least one server device of the server 1 executing software. Typically, the server 1 has a hardware configuration using a normal computer that includes a processor, a random access memory (RAM), a read only memory (ROM), a recording device, an input and output interface (I/F), a network I/F, and a power supply. In the server 1, the processor loads a program stored in the ROM or the like into the RAM and executes the program, that is, executes the application, and thus each function of the behavior suggestion device 10 (see FIG. 2) is realized.

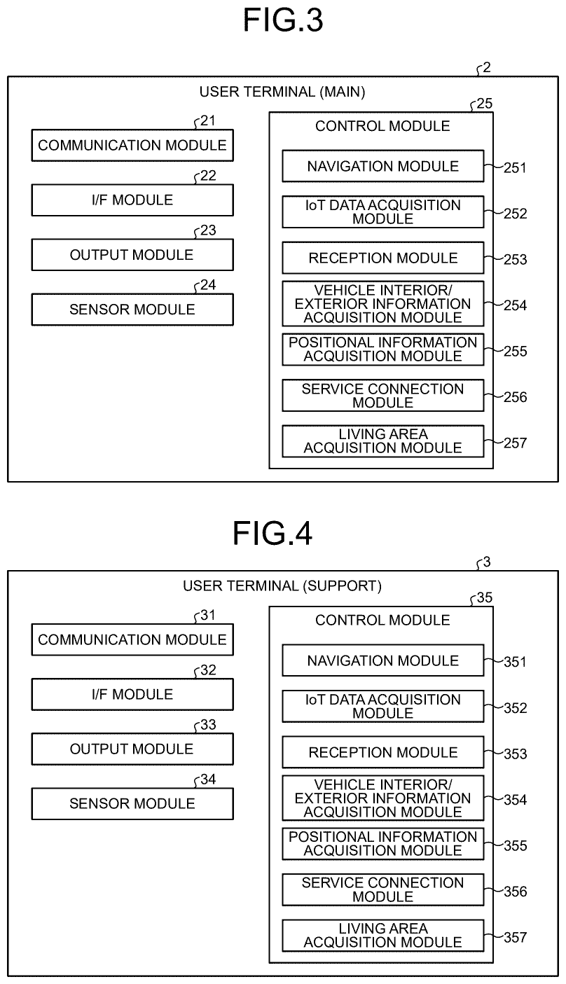

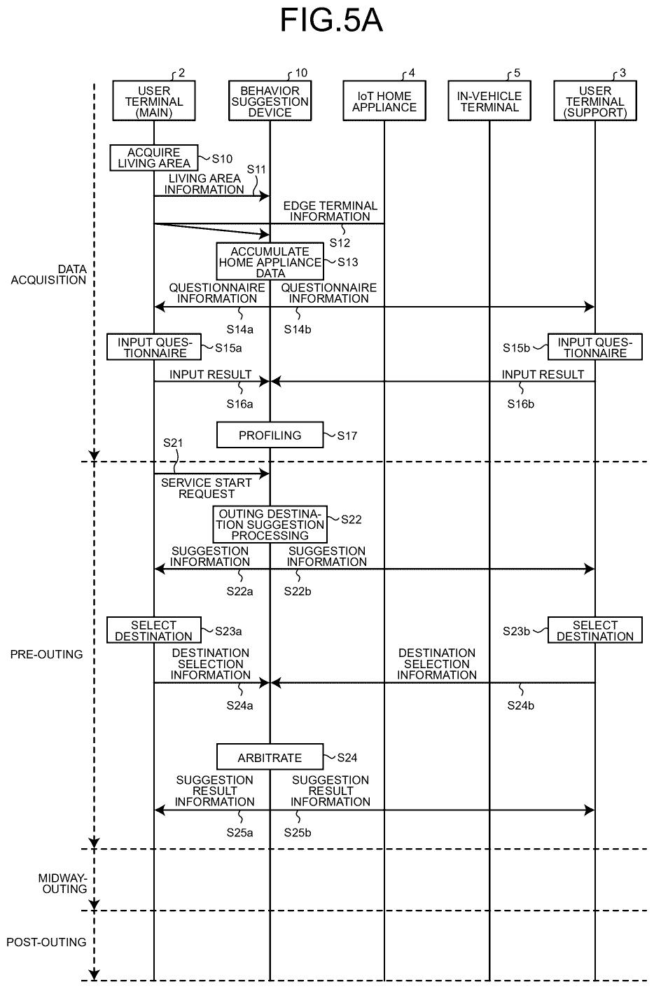

The user terminals 2 and 3 are information terminals used by users of a service provided by the behavior suggestion device 10. In the present embodiment, a user of the main user terminal 2 (main user) is a target person such as an elderly person who is encouraged to make a behavior modification. A user of the support user terminal 3 (sub-user) is at least one user such as a child or a grandchild of the elderly person, in which the sub-user supports the behavior modification of the target person. Of course, a plurality of support user terminals 3 may be prepared for each sub-user such as a son, a daughter, or a grandchild of an elderly person (target person), in which the sub-users support the target person. The user terminals 2 and 3 are smartphones, as an example, and have a hardware configuration that includes a processor, a RAM, a ROM, a recording device, an input and output I/F, a network I/F, a wireless communication I/F, a sensor such as a GPS, and a power source. In the user terminals 2 and 3, the processor loads a program stored in the ROM or the like into the RAM and executes the program, that is, executes the application, and thus each function of the user terminals 2 and 3 (see FIGS. 3 and 4) is realized.

Here, the main user terminal 2 is an example of a first information terminal. The main user such as the elderly person is an example of a first user. The support user terminal 3 is an example of a second information terminal. The sub-user such as a child generation or a grandchild generation of the elderly person is an example of a second user.

As the processors of the server 1 and the user terminals 2 and 3, various processors such as a central processing unit (CPU), a graphics processing unit (GPU), and a digital signal processor (DSP), dedicated arithmetic circuits realized by an application specific integrated circuit (ASIC) and a field programmable gate array (FPGA), and the like can be used as appropriate.

As the recording devices of the server 1 and the user terminals 2 and 3, various recording media and recording devices such as a hard disk drive (HDD), a solid state drive (SSD), and a flash memory can be used as appropriate.

In the behavior suggestion system 7, at least one of the user terminals 2 and 3 and each of the at least one network device are communicably connected to each other in a wired or wireless manner. In the example of FIG. 1, each of the IoT home appliance 4 and the in-vehicle terminal 5 is connected to the main user terminal 2 by short-range wireless communication such as Wi-Fi (registered trademark), Bluetooth (registered trademark), or the like, and communicates with the server 1 via the main user terminal 2.

Examples of the IoT home appliance 4 include power home appliances such as a power distribution device, a lighting fixture, a solar cell, and a charger. Examples of the IoT home appliance 4 include devices such as a TV, a VTR, an AI speaker, an on-demand video reception device, and a game device that present video, music, and game content to users. Examples of the IoT home appliance 4 include cooking home appliances such as a coffee maker and a microwave oven, clean home appliances such as a washing machine, a dishwasher, and a vacuum cleaner, sanitary home appliances such as a bath and a toilet, and air conditioners such as a ventilation fan, an electric fan, a cooler, and an air cleaner. Examples of the IoT home appliance 4 include health home appliances such as a blood pressure gauge, a scale, and a smartwatch that acquires a heart rate and movement data, and monitoring devices such as a door phone, a baby monitor, and a security camera.

Two or more IoT home appliances 4 may be communicably connected. The IoT home appliance 4 is configured to be able to acquire at least IoT data (edge terminal information) of an own device. The IoT home appliance 4 is configured to be able to transmit the acquired IoT data of the own device to the connected user terminal that is any one of the user terminals 2 and 3. The IoT home appliance 4 may transmit the IoT data of the own device to any one of the user terminals 2 and 3 via another IoT home appliance 4.

Here, the IoT data (edge terminal information) of the IoT home appliance 4 is, for example, product information, power ON/OFF information, and operation status information.

The product information may include information regarding types of products of the IoT home appliance 4 such as cooking home appliances such as a coffee maker and a microwave oven, beauty home appliances such as a drier and a steamer, air conditioning home appliances such as an air conditioner, a refrigerator, a lighting, and a TV, and information regarding types of products such as entry-level models, volume-level models, high-grade models, and selected models.

When the IoT home appliance 4 is a TV, the operation status information may include information regarding a viewed channel and program information. When the IoT home appliance 4 is an air conditioner, the operation status information may include information regarding operation menus such as rapid cooling and high power air blowing. When the IoT home appliance 4 is a microwave oven, the operation status information may include information indicating whether only a heating time setting is used or a cooking menu is used.

The in-vehicle terminal 5 is an information processing terminal mounted on a vehicle and is realized by, for example, a computer such as an electronic control module (ECU) or an on board unit (OBU) provided inside a vehicle. The in-vehicle terminal 5 may be an external computer installed near a dashboard of a vehicle or the like or may also serve as a car navigation device or the like.

A vehicle to which the in-vehicle terminal 5 is attached is typically an automobile, but may be any mobility (moving body) capable of transporting people, and may be an electric cart such as a motorcycle, a bicycle, an electric scooter, an electric wheelchair, or a senior car. The mobility may be an autonomous vehicle that performs automated driving. As the mobility, a drone capable of transporting people may be used.

A vehicle configured as a connected car includes a communication module that communicates with the outside. Here, the in-vehicle terminal 5 may directly communicate with the server 1 without involving the user terminals 2 and 3.

### About Behavior Suggestion Device

FIG. 2 is a diagram illustrating an example of a functional configuration of the behavior suggestion device 10 according to the embodiment. The behavior suggestion device 10 implements functions as a reception module 11, an output module 12, a control module 14, a communication module 13, and a recording module 15 by causing a processor to execute a program loaded in a memory such as a RAM.

The reception module 11 receives an instruction from an operator from an input and output I/F such as a keyboard and a mouse. An operator may be substituted with an AI. Then, the reception module 11 may receive an instruction from an AI without involving an input and output I/F.

The output module 12 outputs video information and audio information to the outside through a display or a speaker.

The communication module 13 communicates with the user terminals 2 and 3 connected to the network 6 via a network interface. Here, the communication module 13 is an example of an acquisition unit and a suggestion unit.

The control module 14 is an application executed by the behavior suggestion device 10, which includes a communication module 141, a behavior suggestion module 142, a behavior determination module 143, a learning module 144, a behavior record/reproduction module 145, and a satisfaction level calculation module 146.

The communication module 141 implements a closed SNS between the main user terminal 2 and the support user terminal 3. Here, the phrase “between the main user terminal 2 and the support user terminal 3” means “between member user terminals”.

The closed SNS is a service for sharing a conversation (chat) or photograph information only within a user group. Here, the user group is a group such as a family indicated by user group information 15h stored in the recording module 15. The closed SNS is used to exchange and gather opinions regarding suggested destination candidates. When the main user goes out to the suggested destination, the closed SNS is used as an application for sharing behavior recollection information 15e of the destination.

The behavior suggestion module 142 suggests a destination for causing a behavior modification to the main user such as an elderly person. Here, the behavior suggestion module 142 is an example of an acquisition unit, a selection unit, and a suggestion unit.

As an example, the behavior suggestion module 142 serving as the acquisition unit causes the communication module 13 to communicate with the main user terminal 2 used by the main user via the network 6. The behavior suggestion module 142 causes the communication module 13 to acquire user information of the main user received by the main user terminal 2. Here, the user information of the main user includes living area information 15b indicating a living area of the main user.

As an example, the behavior suggestion module 142 serving as the acquisition unit causes the communication module 13 to communicate with the support user terminal 3 used by the sub-user such as a child via the network 6. The behavior suggestion module 142 causes the communication module 13 to acquire user information of the sub-user received by the support user terminal 3.

As an example, the behavior suggestion module 142 serving as the acquisition unit causes the communication module 13 to further acquire positional information indicating a position of the main user terminal 2 in route guidance to the destination based on the suggestion information.

As an example, the behavior suggestion module 142 serving as the selection unit selects a destination to be suggested from destination candidate information 15a based on profiling information obtained by analyzing the user information of the main user. For example, the behavior suggestion module 142 selects one or more destinations different from at least a geographical range indicated by the living area information of the main user. The selected one or more destinations may be over or beyond at least the geographical range.

As an example, the behavior suggestion module 142 serving as the selection unit further selects one or more destinations from the destination candidate information 15a as a suggested destination based on the profiling information obtained by analyzing the user information of the sub-user, the selected destination being different from the destination based on the profiling information of the main user.

As an example, the behavior suggestion module 142 serving as the selection unit inputs the profiling information obtained by analyzing the user information to a learning information model 15d, and acquires the destination output from the learning information model 15d (output value) in response to an input of the profiling information, that is, an estimated destination, as a destination to be selected, that is, a destination to be suggested.

As an example, the behavior suggestion module 142 serving as the suggestion unit causes the communication module 13 to output suggestion information for suggesting a destination selected by a user in at least one of the user terminals 2 and 3 to at least one of the user terminals 2 and 3.

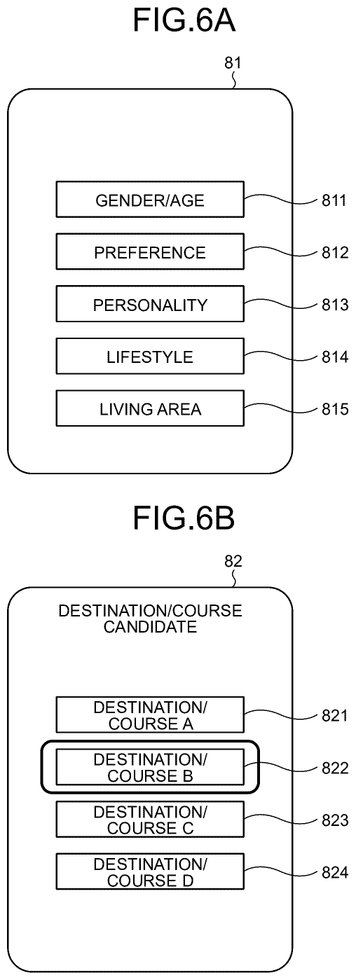

As an example, the behavior suggestion module 142 serving as the suggestion unit causes the communication module 13 to output, to the main user terminal 2, suggestion information for suggesting the destination selected by the main user and the destination selected by the sub-user to the main user to be comparable with each other (see FIG. 6C).

The behavior determination module 143 determines whether a behavior modification is caused by a suggestion of the destination. Here, the behavior determination module 143 is an example of a determination unit.

As an example, the behavior determination module 143 determines whether the suggestion information output to the main user terminal 2 is successful data that caused the behavior modification of the main user. For example, the behavior determination module 143 determines whether the suggestion information is successful data based on the positional information of the main user terminal 2 and the living area information of the main user.

As an example, when route guidance to a destination based on the suggestion information is started in the main user terminal 2, the behavior determination module 143 determines that the suggestion information is successful data.

As an example, the behavior determination module 143 does not treat outing to a long distance by means such as a train or an airplane other than a vehicle as successful data. According to such configuration, it is possible to inhibit a decrease in accuracy of a destination suggestion associated with outing from a viewpoint different from promotion of a behavior modification, such as a journey about once a year.

The learning module 144 performs machine learning on the learning information model 15d.

As an example, the learning module 144 learns parameters of the learning information model 15d so that a destination according to the input profiling information is output among one or more destinations included in the destination candidate information 15a.

As an example, the learning module 144 learns the parameters of the learning information model 15d by using the destination based on the suggestion information determined to be successful data and the profiling information corresponding to the destination.

The behavior record/reproduction module 145 generates the behavior recollection information 15e.

The satisfaction level calculation module 146 calculates a satisfaction level. Here, the satisfaction level is information indicating a level of satisfaction of a user inside and outside of a vehicle in outing to a destination based on the suggestion information. The satisfaction level influences habituation and continuity of outing, and continuation of a destination suggestion with a high satisfaction level promotes habituation of outing and becomes an element of long-term successful data, a so-called “hooking” element. Here, the satisfaction level calculation module 146 is an example of a calculation unit.

As an example, the satisfaction level calculation module 146 calculates the satisfaction level of the user with respect to the destination based on the suggestion information determined to be successful data. The satisfaction level calculation module 146 stores information indicating the calculated satisfaction level in the recording module 15 as satisfaction level information 15f. The satisfaction level calculation module 146 causes the communication module 13 to output the satisfaction level information 15f indicating the calculated satisfaction level to at least one of the user terminals 2 and 3.

As an example, the satisfaction level calculation module 146 calculates the satisfaction level by detecting an audio of a pleasant conversation in the vehicle moving to the destination, performing image analysis of a smile of a person from video information in the vehicle, and the like. For example, the satisfaction level calculation module 146 scores the number of detections of the smile image in which a smile of a user (for example, the main user) is recognized or the number of detections of a laughter among images obtained by a camera in the vehicle or the user terminals 2 and 3 during outing. The satisfaction level calculation module 146 may calculate the satisfaction level by, for example, an amount of photograph information captured outside of the vehicle or image analysis. For example, when the satisfaction level calculation module 146 scores the satisfaction level, if a smile image is detected 10 times or more, the satisfaction level is 10 points, and if there is a smile image of a companion (for example, a sub-user) in the smile image, 10 points is further added or the like. The satisfaction level calculation module 146 similarly adds points for audios based on the number of detections of a laughter of the audio in the vehicle and whether there is a companion. The satisfaction level calculation module 146 also adds points to the number of photographs and videos captured by the user terminals 2 and 3 inside and outside of the vehicle.

The recording module 15 stores the destination candidate information 15a, the living area information 15b, a point information table 15c, the learning information model 15d, the behavior recollection information 15e, the satisfaction level information 15f, profile information 15g, the user group information 15h, questionnaire information 15i, reserved route information 15j, and positional information 15k. Here, the recording module 15 is an example of a recording module.

The destination candidate information 15a is information including one or more destination candidates. Specifically, the destination candidate information 15a is information indicating one or more destinations that are outing goal destinations. The destination candidate information 15a may include a transit point during the way to the destination. As the destination, a typical tourist spot may be set, or a spot where the satisfaction level of another main user or sub-user was high may be set. In addition, a spot that the main user did not visit in the vicinity outside of a living area may be set as a destination. It is assumed that information indicating the destination is information such as an address, latitude/longitude, or the like by which a route on a map can be guided with at least a car navigation function.

The living area information 15b is information indicating a living area of the main user. As an example, the living area information 15b is defined by a predetermined rule, such as within a radius of 2 km from residence of the main user confirmed in a questionnaire or the like. Of course, the living area information 15b may be defined based on the positional information of the main user terminal 2.

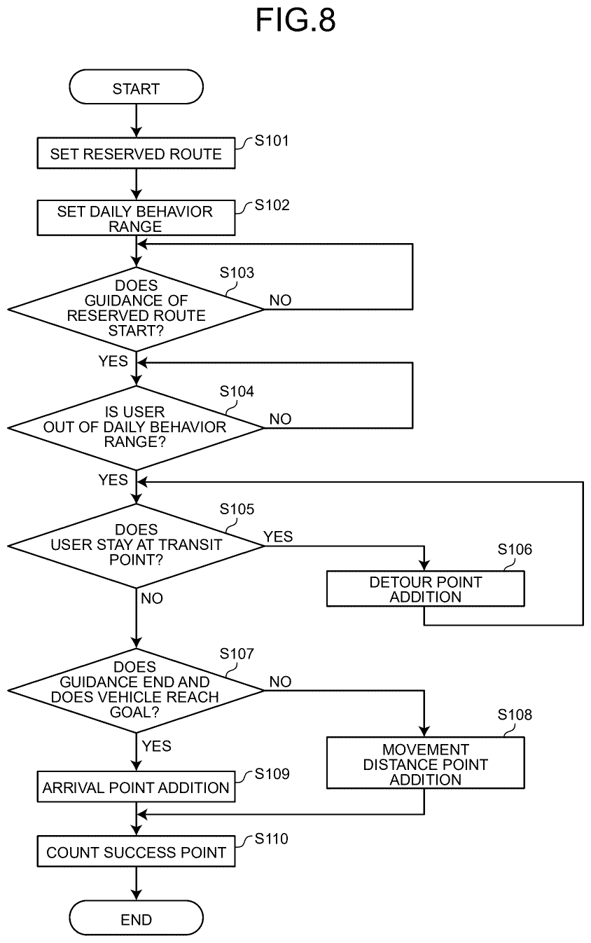

The point information table 15c is a table (see FIG. 9) indicating an increase in a level of a behavior modification of outing by adding points.

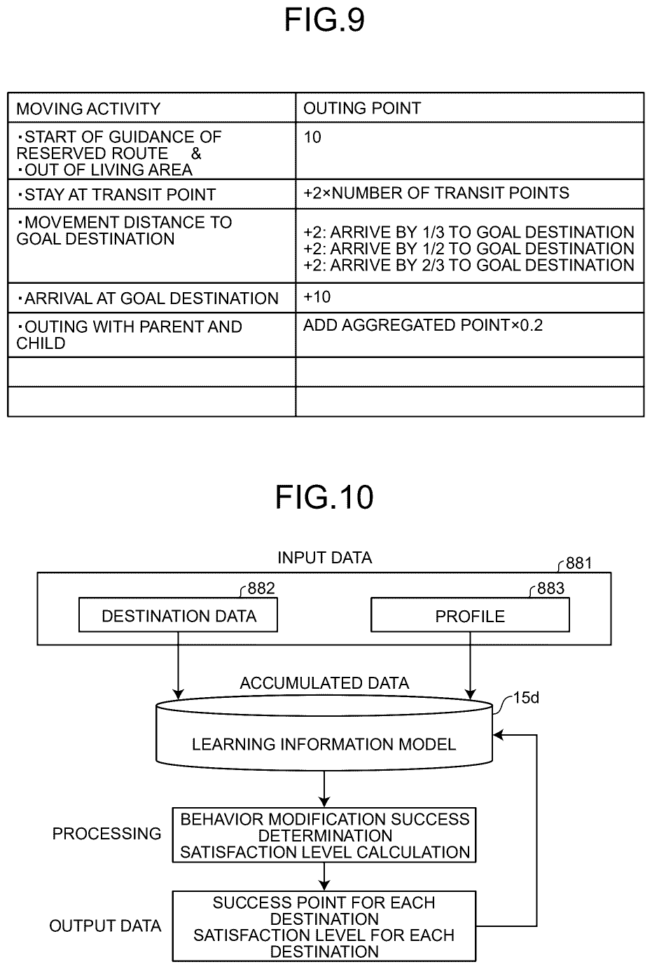

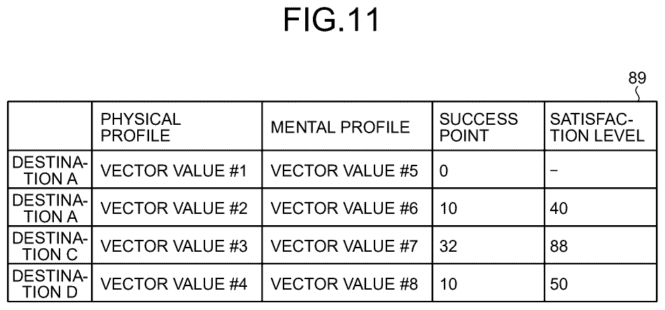

The learning information model 15d is a machine learning model in which parameters are learned so that a destination corresponding to the input profiling information is output among one or more destinations included in the destination candidate information 15a. Details of the learning information model 15d will be described below (see FIGS. 10 and 11).

The learning information model 15d may be stored outside of the behavior suggestion device 10. Then, the behavior suggestion module 142 executes input and output with respect to the learning information model 15d via the communication module 13.

The behavior recollection information 15e is information generated by the behavior record/reproduction module 145. As the behavior recollection information 15e, information of a video, a photograph, and an audio inside and outside of the vehicle during the outing to the suggested destination is recorded. The behavior recollection information 15e includes a photograph in which a companion can be known, a photograph in which a participant looks happy, and a video of a beautiful scene or a tourist point. The behavior recollection information 15e may include data of an image, a video, or an audio subjected to digest processing for picking up the image, the video, or the audio, or processing for chronologically arranging images, videos, or audios.

The image information, the video information, and the audio information are acquired through a camera or a microphone attached to the user terminals 2 and 3 and the in-vehicle terminal 5, and are taken into the behavior suggestion device 10 by the communication module 13.

The behavior recollection information 15e may include a travel route to the destination as animation data synthesized with bird's-eye view 3D map information. The behavior recollection information 15e may include an audio or a background music inside the vehicle.

The satisfaction level information 15f is information indicating a level of satisfaction calculated by the satisfaction level calculation module 146. The satisfaction level information 15f may include an image, a video, or an audio used to calculate the satisfaction level or may include a detection result of a smile or a laughter in the image, the video, or the audio.

The profile information 15g is information obtained by analyzing at least the user information of the user terminals 2 and 3. The profile information 15g may be generated through analysis by the behavior suggestion device 10 such as the behavior suggestion module 142 or may be generated through analysis outside of the behavior suggestion device 10. Here, the profile information 15g is an example of the profiling information.

As an example, the profile information 15g is generated through analysis of a user reply of a questionnaire (user information) or analysis of data acquired from the IoT home appliance 4. The profile information 15g is vector values obtained by combining each analyzed factor. The profile information 15g may be classified into categories and have vector values, and according to the embodiment of the present disclosure, each of the categories of physical profile information and mental profile information has a vector value (see FIG. 11).

The user group information 15h is information indicating a relationship between a user (main user) of one main user terminal 2 and a user (sub-user) of one or more support user terminals 3. As an example of an embodiment of the present disclosure, the main user is an elderly person, and the sub-user is a child or a grandchild who is a family member of the elderly person. The information indicating the relationship is used in arbitration when an elderly person who is the main user selects a suggested destination. Typically, the final determination is left to the main user, but the main user selects which destination is prioritized from a favorite destination of themselves and a favorite destination of the sub-user such as a child or a grandchild.

The questionnaire information 15i is information for presenting a questionnaire to the users on the user terminals 2 and 3 (see FIG. 6A). Reply of the user to the questionnaire questions (user information) are analyzed as the profile information 15g and recorded in the recording module 15 as described above.

Typically, “questions of preference” of the questionnaire are questions for confirming content preferred by the user in journey or outing such as preference of history, preference of eating, preference of visiting temples and shrines, preference of walking, preference of driving a car, preference of enjoying nature, and preference of photographing. “Preference” may also be obtained through IoT data analysis from IoT appliances. Typically, “preference” is estimated according to a genre of viewing information of TV.

“Questions about personality” of the questionnaire indicates that the user wants to enjoy for a long time, wants to enjoy for a minimum time, or the like. In psychology, there is a personality diagnosis called “Big 5”, and personality is classified by a five-factor model of openness, conscientiousness, extraversion, agreeableness, and neuroticism. Of course, the questions in the questionnaire may be questions for deriving the five factors.

“Lifestyle questions” in the questionnaire include “preference of cleanliness”, “preference of eco-friendly life”, and “early get-up”. For the lifestyle, information is also generated by analyzing IoT data from the IoT home appliance 4 in addition to the user replies of the questionnaire. For example, it is possible to estimate preference of cleanliness if the number of times of operation of a washing machine or a vacuum cleaner is large, estimate preference of eco-friendly life if the user owns a large number of eco-friendly home appliances, and estimate a living time zone, early rising, and regularity/irregularity from ON/OFF of lighting.

For “questions about living area” in the questionnaire, an address of the user is confirmed. The living area is analyzed as a predetermined radius such as a radius of 2 km from the confirmed address and is recorded as the living area information 15b. The living area information may statistically differ by age and gender. The positional information acquired by a positional information acquisition module 255 of the main user terminal 2 may be analyzed, and a daily moving range may be used as living area information. Then, a care facility, a community center, an agricultural cooperative, a commuting destination, and the like that are visited on a daily basis over 2 km can also be determined as the living area. The living area information 15b is not limited to the case of acquisition from a questionnaire result and may be information generated by a living area acquisition module 257 of the main user terminal 2.

The reserved route information 15j is route information for guiding a user to the suggested destination.

The positional information 15k is positional information of the main user acquired by the positional information acquisition module 255 of the main user terminal 2.

### About User Terminal

FIG. 3 is a diagram illustrating an example of a functional configuration of the user terminal according to the embodiment that is the main user terminal 2 used by the main user who receives a suggestion. The main user terminal 2 implements functions as a communication module 21, an I/F module 22, an output module 23, a sensor module 24, and a control module 25 by causing a processor to execute a program loaded on a memory such as a RAM.

The communication module 21 communicates with the behavior suggestion device 10 via a network I/F. The communication module 21 communicates with the IoT home appliance 4 and the in-vehicle terminal 5 via a wireless communication I/F.

The communication module 21 also communicates with the support user terminal 3. The communication may be wireless communication compatible with various standards such as 3G, 4G, Wi-Fi (registered trademark), and Bluetooth (registered trademark) or may be performed via the Internet. The communication between the user terminals 2 and 3 is also performed via the behavior suggestion device 10. In the communication, typically, the communication module 141 of the behavior suggestion device 10 functions as a closed SNS, and a chat or a photograph is exchanged.

The I/F module 22 is a user interface such as a camera, a microphone, or a touch panel, and typically receives an instruction from the main user through a touch panel or voice recognition.

The output module 23 is a display or a speaker, and outputs video information and audio information.

The sensor module 24 is a global positioning system (GPS) sensor that acquires positional information, an angular velocity sensor, or a biosensor that measures a pulse.

The control module 25 is an application executed in the main user terminal 2, which includes a navigation module 251, an IoT data acquisition module 252, a reception module 253, a vehicle interior/exterior information acquisition module 254, the positional information acquisition module 255, a service connection module 256, and the living area acquisition module 257.

The navigation module 251 generates guidance information for guiding the main user to a designated destination (for example, a destination based on the suggestion information) and outputs the guidance information to the outside via the output module 23 (see FIG. 6D). The guidance information is typically information for superimposing and displaying an own vehicle position, a direction to a destination, an estimated arrival time, track information of an intersection, guide information, and the like regarding a route on map information.

The IoT data acquisition module 252 acquires data from the communicable IoT home appliance 4 via the communication module 21. Data from the IoT home appliance 4 can be directly acquired via an I/F such as Wi-Fi or indirectly acquired from an I/F such as Wi-Fi of a smart remote controller that transmits a command to the IoT home appliance 4. A device that analyzes data acquired by the IoT home appliance 4 and performs mild cognitive impairment (MCI) diagnosis also serves as the IoT home appliance 4 that is a data acquisition destination.

The reception module 253 receives an instruction from the main user via the I/F module 22. Typically, the reception module 253 receives a user instruction through a touch panel or voice recognition.

As an example, the reception module 253 causes the output module 23 to output (present) a screen 81 (see FIG. 6A) for receiving the user information. The reception module 253 causes the I/F module 22 to receive user information of the main user including living area information indicating the living area of the main user who uses the main user terminal 2. The reception module 253 causes the communication module 21 to transmit the received user information of the main user to the connected suggestion service (the behavior suggestion device 10).

As an example, the reception module 253 causes the communication module 21 to acquire the suggestion information from the behavior suggestion device 10. The suggestion information includes information indicating a destination selected from the destination candidate information 15a based on the profile information 15g obtained by analyzing the user information of the main user. The reception module 253 causes the output module 23 to output (present) a screen 82 (see FIG. 6B) for presenting the destination based on the suggestion information to the main user. The reception module 253 causes the output module 23 to output (present) a screen 83 (see FIG. 6C) for accepting designation (selection) of a destination to go for outing among a plurality of destinations based on the suggestion information. The reception module 253 causes the I/F module 22 to receive designation (selection) of a destination by the main user.

The vehicle interior/exterior information acquisition module 254 acquires information regarding the interior of the vehicle and the exterior of the vehicle via a camera or a microphone of the I/F module 22. The vehicle interior/exterior information acquisition module 254 acquires videos, photographs, audios, and the like of inside and outside of the vehicle. The acquisition of the information inside and outside of the vehicle by the vehicle interior/exterior information acquisition module 254 may be acquisition of AR content in which video data linked with the positional information is acquired from the outside via the network 6.

The positional information acquisition module 255 acquires the positional information of the main user terminal 2 via the GPS sensor of the sensor module 24. The positional information acquisition module 255 causes the communication module 21 to transmit the acquired positional information to the connected suggestion service.

The service connection module 256 makes connection to a suggestion service for suggesting a behavior destination. For example, the service connection module 256 connects the main user terminal 2 to the suggestion service provided by the behavior suggestion device 10. As an example, the service connection module 256 executes connection processing with the behavior suggestion device 10 necessary to manage contract information and billing information of the main user who uses the suggestion service, account information associated with the contract information and the billing information, and login information and to use the service.

The living area acquisition module 257 may generate the living area information 15b of the main user through statistical processing based on the positional information associated with the movement of the main user terminal 2. In the statistical processing, for example, a circle area of a geographical range that has an average distance of a spot repeatedly reached from a home on a weekly basis as a radius is defined as the living area information 15b. A distant point to be reached by commuting or the like may be excluded from the statistical processing as a singularity or may be combined with another circle area as an elliptic area that has a diameter between the distant point and the home. When the living area information 15b is acquired only based on a reply to the questionnaire, the user terminals 2 and 3 may not be provided with the living area acquisition module 257.

The behavior suggestion device 10 (server 1) and the main user terminal 2 execute a suggestion service through server and client processing. The execution of the suggestion service through the server and client processing is not limited to the above-described configuration. For example, in the case of a cloud-native system configuration, the navigation module 251, the IoT data acquisition module 252, the reception module 253, the vehicle interior/exterior information acquisition module 254, and the positional information acquisition module 255 that are applications executed by the control module 25 of a client side may be executed as applications of the control module 14 of a server side. Then, the application executed in the control module 25 of the client side serves as a browser unit (not illustrated) that receives services through the service connection module 256 and the server 1 and displays a web browser.

FIG. 4 is a diagram illustrating an example of a functional configuration of the user terminal according to the embodiment that is the support user terminal 3 used by another user (sub-user) who supports the main user who receives the suggestion. The support user terminal 3 realizes functions as a communication module 31, an I/F module 32, an output module 33, a sensor module 34, and a control module 35 by causing a processor to execute a program loaded on a memory such as a RAM. The control module 35 is an application executed in the main user terminal 2, which includes a navigation module 351, an IoT data acquisition module 352, a reception module 353, a vehicle interior/exterior information acquisition module 354, the positional information acquisition module 355, a service connection module 356, and the living area acquisition module 357.

In principle, the support user terminal 3 and the main user terminal 2 are the same except that a user in a user group is different. Here, the user group is typically a group formed by family members and relatives. In the present embodiment, the user of the main user terminal 2 is a user (main user) such as an elderly person. The user of the support user terminal 3 is a child or a grandchild of the main user such as an elderly person, and is a sub-user who supports the main user.

The main user and the sub-user, that is, the user terminals 2 and 3 are identified by the behavior suggestion device 10, and the relationship is managed based on the user group information 15h.

Unless otherwise mentioned, the communication module 31, the I/F module 32, the output module 33, the sensor module 34, and the control module 35 of the support user terminal 3 correspond to the communication module 21, the I/F module 22, the output module 23, the sensor module 24, and the control module 25 of the main user terminal 2, respectively, and a detailed description thereof will be omitted.

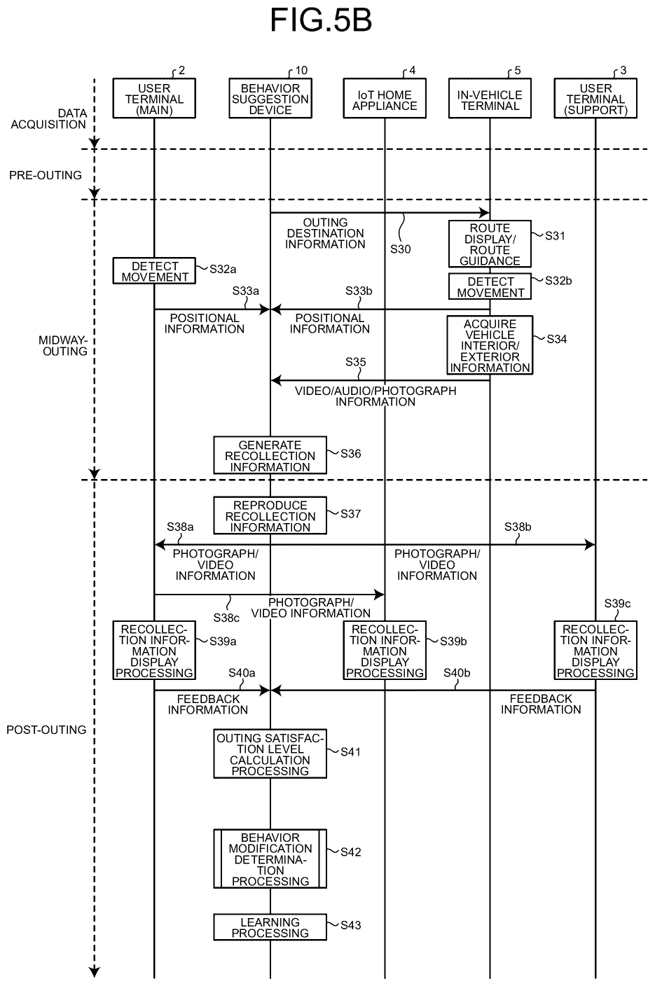

The server 1 may be a plurality of server devices that communicate via a network. Then, each server shares a role and starts a program respectively using an application program interface (API) to exchange data. Examples of the roles to be shared include a role of profiling the user using the data of the IoT home appliance 4 and questionnaire information (see S13 and S17 of FIG. 5A), a role of suggesting an outing destination and arbitrating selection of the user based on a profiling result (see S22 and S24 of FIG. 5A), a role of displaying and guiding a route for a moving vehicle, detecting positional information, acquiring vehicle interior/exterior information and generating and reproducing recollection information (see S31, S32, S33, S34, and S36 of FIG. 5B), and a role of calculating an outing satisfaction level, determining a behavior modification, and performing learning processing (see S41, S42, and S43 of FIG. 5B).

Next, a flow of processing executed by the behavior suggestion system 7 configured as described above will be described.

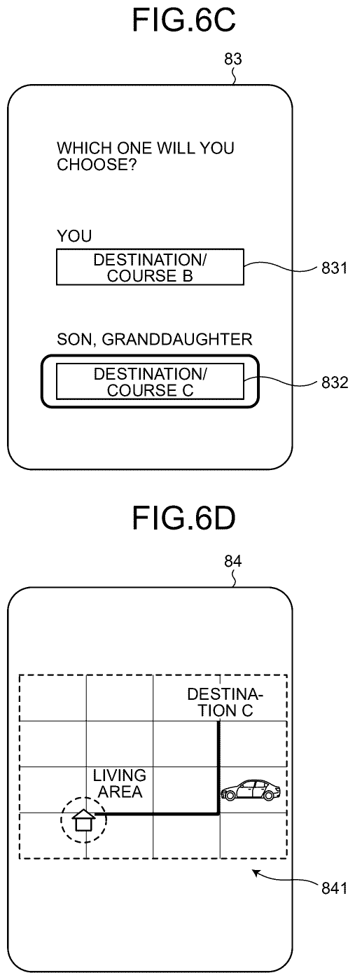

FIGS. 5A and 5B are sequence charts illustrating an example of a sequence of information processing executed in the behavior suggestion system 7 according to the embodiment. FIGS. 6A to 6D are diagrams illustrating examples of display screens displayed on the user terminals 2 and 3 in the information processing. FIGS. 7A and 7B are diagrams illustrating an example of a display screen displayed on a TV that is the IoT home appliance 4, for example, in the recollection information display processing of FIG. 5B.

Note that the display screens of FIGS. 6A to 6D may be displayed on the IoT home appliance 4 or the in-vehicle terminal 5. Further, the display screens of FIGS. 7A and 7B may be displayed on the user terminals 2 and 3 or the in-vehicle terminal 5.

The sequence charts in FIGS. 5A and 5B illustrate processing and input and output of information of each of the user terminals 2 and 3, the IoT home appliance 4, the in-vehicle terminal 5, and the behavior suggestion device 10 configuring the behavior suggestion system 7.

FIG. 5A illustrates processing of a first half of a series of sequence charts, specifically, a data acquisition part and a pre-outing part. FIG. 5B illustrates processing of the second half of a sequence chart, specifically, a during-outing part and a post-outing part.

### Data Acquisition Part

First, the data acquisition part will be described.

In the main user terminal 2, the living area acquisition module 257 acquires the living area information of the main user (S10). The main user terminal 2 outputs the acquired living area information to the behavior suggestion device 10 (S11). Then, the behavior suggestion device 10 records the received living area information as living area information 15b in the recording module 15.

The IoT home appliance 4 acquires edge terminal information of the own device and outputs the acquired edge terminal information to the behavior suggestion device 10 via the main user terminal 2 (S12). Here, the edge terminal information is IoT data as described above and is information indicating ON/OFF of a power supply of the own device or an operation status and product information. Then, the behavior suggestion device 10 performs processing for accumulating the received edge terminal information as home appliance data (S13). The accumulated home appliance data is profiled along with questionnaire information in profiling processing (see S17) to be described below.

The behavior suggestion device 10 transmits the questionnaire information 15i to the user terminals 2 and 3 (S14a and S14b). Then, the user terminals 2 and 3 present the screen 81 for receiving a questionnaire input from the user to the user based on the received questionnaire information 15i.

FIG. 6A exemplifies the screen 81 of the user terminals 2 and 3 that receive the questionnaire input. The screen 81 includes items 811 to 815 of gender/age, preference, personality, lifestyle, and a living area as questionnaire input items. The user replies to the questions presented by each item on the screen 81. The user terminals 2 and 3 receive replies of the users by the reception module 253 (S15a and S15b), and transmit an input result of the received questionnaire to the behavior suggestion device 10 (S16a and S16b). Then, the behavior suggestion device 10 performs profiling processing of the main user and the sub-user based on the received input result of the questionnaire and the accumulated IoT data (S17).

In the profiling processing, the profile information 15g (profiling information) is generated for each target user. The profiling information includes a physical profile and a mental profile (see FIG. 11). The physical profile is vector values of information analyzed and formed from health data unique to a living individual, such as race, height, gender, weight, age, and blood pressure. The mental profile is mental information independent of the body and is vector values of information formed by analyzing personality data such as preference, lifestyle, and Big 5 in psychology. Such values are vector values formed by multi-value synthesis such as preference A 40%, preference B 30%, preference C 15%, and preference D 15%.

### Pre-Outing Part

Next, the pre-outing part will be described.

The main user terminal 2 transmits a service start request to the behavior suggestion device 10 (S21). The service is a suggestion service that realizes a destination suggestion to the user.

The behavior suggestion device 10 that received the service start request performs outing suggestion processing based on the profile information 15g of the suggested user (S22), and transmits suggestion information of a destination that is an outing target to the user terminals 2 and 3 (S22a and S22b). As an example of an algorithm for performing the suggestion processing, there is collaborative filtering. A past destination record of the user having similar profile information 15g to the user is suggested as the destination candidate. As the destination record, data accumulated as successful data in the learning information model 15d (see FIG. 11) is used. The profile information and the data of a destination record may be acquired from the outside and used.

In the user terminals 2 and 3, the reception module 253 performs destination selection processing based on the suggestion information of the received destination by receiving a user input (S23a and S23b). For example, the user terminals 2 and 3 present the screen 82 for selecting a destination based on the suggestion information, that is, from suggested destination candidates, to the user.

FIG. 6B illustrates the screen 82 of the user terminals 2 and 3 that presents a destination based on the suggestion information to the user. The screen 82 includes displays 821 to 824 of at least one destination/course candidate. The user terminals 2 and 3 receive a selection result of the user (S23a and S23b), and transmit destination selection information indicating the received selection result to the behavior suggestion device 10 (S24a and S24b).

The behavior suggestion device 10 receiving the destination selection information performs arbitration processing for arbitrating the destination selection information received from the main user terminal 2 and the destination selection information received from the support user terminal 3 (S24).

For example, in the behavior suggestion device 10, the communication module 13 outputs, to the main user terminal 2, suggestion information for suggesting the destination selected by the main user and the destination selected by the sub-user to the main user to be comparable with each other. Then, the main user terminal 2 presents the screen 83 for arbitration to the user based on the suggestion information.

FIG. 6C exemplifies the screen 83 of the user terminal 2 for arbitration. The screen 83 is a UI that displays a destination/course candidate (B) 831 selected by the profiling of the user of the main user terminal 2 (an elderly person or the like) and a destination/course candidate (C) 832 selected by the profiling of the user of the support user terminal 3 (a child, a grandchild, or the like) to be comparable so that the main user (elderly person or the like) is allowed to select a destination. FIG. 6C exemplifies a case in which the destination/course candidate (C) 832 selected by the profiling of the user of the support user terminal 3 (a child, a grandchild, or the like) is selected by the main user.

As described above, as an example of the arbitration processing according to the embodiment, when there are the destination candidates A and B selected by the main user and the destination candidate C selected by the sub-user, a processing is performed in which the behavior suggestion device 10 is caused to allow the main user to select one of the destination candidates A, B, and C. The main user may select the destination candidate A (for example, a landscape/natural viewpoint) or the destination candidate B (for example, a historical site viewpoint) suggested based on the profile of the main user, or may select the destination candidate C (for example, a park or a pool viewpoint) suggested based on the profile of the sub-user (a child or a grandchild). For the main user (an elderly person or the like), by expanding the range of options to a range other than own preference (supporter/companion), it is possible to expect an effect that the suggestion of the destination can be easily accepted by the main user.

In the arbitration processing, the main user terminal 2 receives a selection result of the main user in the arbitration and transmits the received selection result to the behavior suggestion device 10. Then, the behavior suggestion device 10 transmits the received selection result, that is, an arbitration result, to the user terminals 2 and 3 as suggestion result information (S25a and S25b). As such, the destination suggested by the suggestion service is determined.

### Midway-Outing Part

Next, the midway-outing part will be described.

The behavior suggestion device 10 transmits the route information to the determined destination to the in-vehicle terminal 5 as the outing destination information (S30). The in-vehicle terminal 5 performs route display and route guidance based on the received outing destination information (S31). FIG. 6D exemplifies a screen 84 for route display. The screen 84 includes a route display 841 for guiding the main user to the destination C different from the living area.

Each of the main user terminal 2 and the in-vehicle terminal 5 detects movement of the terminal (S32a and S32b) and transmits positional information to the behavior suggestion device 10 (S33a and S33b). Here, the behavior suggestion device 10 detects the positional information from both the main user terminal 2 and the in-vehicle terminal 5, and one piece of positional information is adopted. Here, if there is positional information transmitted by the in-vehicle terminal 5, the behavior suggestion device 10 gives priority to the positional information from the in-vehicle terminal 5. The in-vehicle terminal 5 may also be used as an application of the main user terminal 2, and then, the positional information transmitted from the in-vehicle terminal 5 is positional information from the main user terminal 2.

Further, the in-vehicle terminal 5 acquires vehicle interior/exterior information obtained through detection with a camera and a microphone (S34). The acquired video information, audio information, and photograph information are transmitted to the behavior suggestion device 10 (S35), and the behavior suggestion device 10 generates the behavior recollection information 15e that is a digest video (S36). The behavior suggestion device 10 may generate the behavior recollection information 15e using the video information, the audio information, and the photograph information acquired by the cameras and the microphones of the user terminals 2 and 3 determined to be in the same range (for example, inside the vehicle) based on a detection result of the positional information of the terminals in addition to the in-vehicle terminal 5. When the vehicle reaches the suggested destination, the behavior suggestion device 10 may generate the behavior recollection information 15e using the video information, the audio information, and the photograph information acquired by the cameras and the microphones of the user terminals 2 and 3 instead of the in-vehicle terminal 5.

### Post-Outing Part

Next, the post-outing part will be described.

The behavior suggestion device 10 reproduces the behavior recollection information 15e (S37). The start of reproduction may be a request type from the user or a push type from the user terminals 2 and 3 or the behavior suggestion device 10. The reproduced photograph/video information is transmitted to the user terminals 2 and 3 (S38a and S38b). The photograph/video information may be transmitted to the IoT home appliance 4 via the main user terminal 2 (S38c). Each of the user terminals 2 and 3 and the IoT home appliance 4 that received the photograph/video information performs display processing of the behavior recollection information 15e (S39a, S39b, and S39c). The display processing may be processing for outputting a photograph or a video in a signage type or may be processing for outputting a photograph or a video in an on-demand type in response to a request from a user.

FIGS. 7A and 7B exemplify screens 85 and 86 for displaying the behavior recollection information 15e.

For example, as illustrated in the screen 85 of FIG. 7A, display of the behavior recollection information 15e may be display 851 indicating the degree of achievement of an arrival destination at which the main user arrived with respect to the living area information 15b on the map information. In the example of FIG. 7A, the arrival destination, that is, an outing destination where the user goes for outing is filled like a map game, and a progress of the degree of achievement of the outing can be easily ascertained. By indicating the degree of achievement as such, a success reward can be given to not only for an elderly person who tends to stay at home but also for an active elderly person, and outing habituation can be expected.

For example, as illustrated in the screen 86 of FIG. 7B, in display of the behavior recollection information 15e, not only an overview 861 such as district information of a destination (B district b1), a satisfaction level, and companion information but also UIs 862 and 863 for reproducing video and audio information inside and outside of the vehicle during the outing may be displayed. A UI 864 of a closed SNS with a companion may be displayed on the screen 86, and the main user can enjoy a conversation looking back on the outing with the companion (for example, the sub-user). An example of the conversation may be, when the companion is a granddaughter, “Grandpa, it was fun, please come with me again” or the like. An album type UI may be displayed. In the outing calculation processing (S41), feedback information for the display of the behavior recollection information 15e, a closed SNS conversation, the number of conversations, or the like may be considered.

When the behavior recollection information 15e is reproduced in a signage type, it is also appropriate from the viewpoint of habituation to display information that promotes the user to make a next outing request. An example of the display may be “You had fun together with your granddaughter in the previous outing (B district). Where are you going next?” or the like.

The user terminals 2 and 3 that performed the display processing of the behavior recollection information 15e transmit feedback information to the behavior suggestion device 10 (S40a and S40b). Examples of the feedback information include the number of times and a time for which the behavior recollection information 15e was displayed.

The behavior suggestion device 10 performs outing satisfaction level calculation processing (S41). The outing satisfaction level calculation processing may be performed before or in parallel with the recollection information display processing (S37). When the outing satisfaction level calculation processing is performed before the recollection information display processing, information indicating the calculated satisfaction level (the satisfaction level information 15f) may be included as a part of the photograph/video information to be transmitted (S38a, S38b, and S38c).

Thereafter, the behavior suggestion device 10 performs behavior modification determination processing (S42) and performs learning processing based on a result of the behavior modification determination processing (S43).

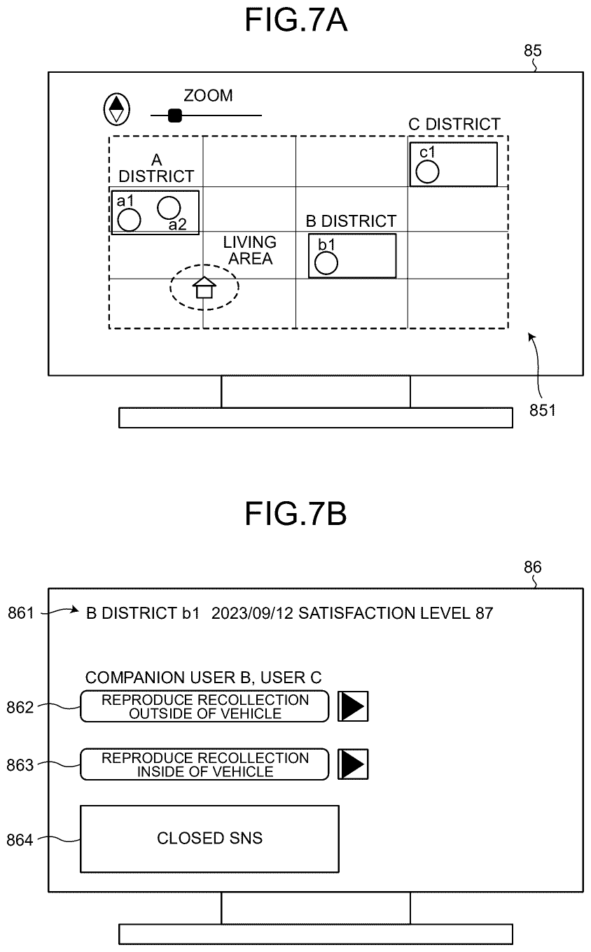

Here, the behavior modification determination processing (S42 in FIG. 5B) will be described in more detail with reference to the drawings. FIG. 8 is a flowchart illustrating an example of a flow of information processing of a destination suggestion of the behavior suggestion device 10. The information processing is, for example, information processing executed by the behavior determination module 143 to determine whether the behavior modification by the suggestion was successful.

First, the behavior determination module 143 sets a reserved route (S101). The processing is performed by setting the reserved route information 15j read from the recording module 15. The behavior determination module 143 sets a daily behavior range (S102). The processing is performed by setting the living area information 15b read from the recording module 15.

Thereafter, the behavior determination module 143 determines whether guidance of the reserved route starts (S103). For example, the behavior determination module 143 determines whether guidance of the reserved route starts based on whether processing of route display/route guidance (S31) in FIG. 5B is executed. The processing of route display/route guidance (S31) by the in-vehicle terminal 5 is performed independently of the departure and movement of the vehicle. The processing of the route display/route guidance (S31) is typically performed before departure to the suggested destination, but may be started when the vehicle is already traveling on another route.

When it is not determined that the guidance of the reserved route starts (S103: No), the behavior determination module 143 executes the processing of S103 again after a predetermined time. When it is determined that the guidance of the reserved route starts (S103: Yes), the behavior determination module 143 determines whether the user is out of the daily behavior range (S104). The determination is made by comparing the positional information 15k recorded in the behavior suggestion device 10 with the living area information 15b. If the current position of the main user terminal 2 and/or the in-vehicle terminal 5 indicated by the positional information 15k is out of the range indicated by the living area information 15b, the behavior determination module 143 determines that the user is out of the daily behavior range. When it is not determined that the positional information 15k is out of the daily activity range (S104: No), the behavior determination module 143 executes the processing of S104 again after a predetermined time.

When the guidance of the reserved route is started and it is determined that the vehicle is out of the daily behavior range (S104: Yes), the behavior determination module 143 determines whether the vehicle stays at a transit point (S105). The determination is made based on whether the positional information indicating a current position of the main user terminal 2 and/or the in-vehicle terminal 5 stays at a base included in or not included in the route for a predetermined time (for example, 20 minutes) or more. The behavior determination module 143 may determine whether the user stayed at the transit point based on the obtained vehicle interior/exterior information (S34). As an example, there is an aspect in which it is determined that the user stayed at the transit point when photographing is performed, and it is determined that the user did not stay at the transit point when the user had a break at a convenience store.

When it is determined that the user stays at the transit point (S105: Yes), the behavior determination module 143 performs detour point addition (S106). When it is not determined that the user stays at the stopover point (S105: No) or after the point addition, the behavior determination module 143 determines whether the guidance ends and the vehicle reaches the destination (S107). The determination is made based on whether the current position of the main user terminal 2 and/or the in-vehicle terminal 5 indicated by the positional information 15k reached an arrival point (destination) indicated by the reserved route information 15j. In the determination, when the route guidance of the in-vehicle terminal 5 ends or is canceled, it is determined that the guidance ends.

When the guidance ends without reaching the destination (S107: No), the behavior determination module 143 performs movement distance point addition (S108). When the guidance ends by reaching the destination (S107: Yes), the behavior determination module 143 performs arrival point addition (S109). the behavior determination module 143 counts the success point and determines whether the suggestion information is successful data based on a counting result of the point (S110). If the counted success point is a valid value, the behavior modification for outing is determined to be successful, and a profile of the user associated with the destination becomes successful data.

For example, the main user makes the behavior modification for outing regarding the suggested destination, guidance of the navigation device to the suggested destination by a private car or the like starts, and if the destination is different from the living area, 10 points are set as an initial value. Thereafter, points are added by stay at a transit point, a movement distance to a goal destination, or the like. If the point is not 0 points, the data is treated as successful data.

Here, the point addition according to the embodiment will be described. FIG. 9 is a diagram illustrating an example of a configuration of the point information table 15c according to the embodiment.

The behavior determination module 143 performs the point addition according to the degree of achievement of the outing with reference to the point information table 15c stored in the recording module 15.

For example, as illustrated in FIG. 9, the behavior determination module 143 adds 10 points when guidance by the navigation function starts out of the daily living area. Here, the data becomes successful data in which the behavior modification for outing is achieved. The subsequent point addition is point addition as the degree of achievement considered in the learning information model 15d to be described below. Whether the behavior modification for outing is caused with respect to the suggested destination is added according to the number of transit points, that is, so-called detours (detour point addition) as illustrated in FIG. 9. Considering the meaning of outing, the goal is not always reaching the initially set destination, and outing is valid including detours. Therefore, point addition (movement distance point addition) is also performed according to an arrival distance to the destination. For example, as illustrated in FIG. 9, the behavior determination module 143 adds movement distance points based on the movement to a goal destination that is a destination and an arrival distance (⅓, ½, ⅔, or the like).

For an elderly person who is an example of an implementation target according to the present embodiment, a sense of achievement is higher when the elderly person reaches a destination with a child generation than when the elderly person reaches the destination alone, thereby the point addition may be performed when the elderly person goes out as parent and child. Here, parent and child was exemplified, but a sub-user who assists outing of an elderly person who is a main user is sufficient, and not only a child of the elderly person but also a granddaughter or another related person is sufficient.

Here, the learning information model 15d according to the embodiment will be described in more detail with reference to the drawings. FIG. 10 is a diagram illustrating the learning information model 15d according to the embodiment. FIG. 11 is a diagram illustrating an example of a configuration of a data set 89 of input data 881 of the learning information model 15d according to the embodiment.

The learning information model 15d is a machine learning model. Data accumulation, that is, learning of the learning information model 15d is performed by the learning module 144 of the control module 14.

Here, the learning of the learning information model 15d will be described.

The “learning information model” is a function in a broad sense that classifies an input value (user profiling information) and outputs an output value (destination) corresponding to the classification. The output value (destination) is a suggestion candidate to the user. The function is also referred to as estimation of the destination by the learning information model 15d.

“Learning of the learning information model” means adjustment of a parameter of a function that is a learning information model. By adjusting the parameter, an output (destination) regarding an input (profiling information) is changed.

Examples of an algorithm of a function that performs classification include a support vector machine (SVM), a regression model, a decision tree, a random forest, and a neural network. The parameter differs for each algorithm, and in the case of a neural network, there are parameters such as the number of neurons, a threshold value, or the number of layers.

Here, the parameter is used in a broad sense and may be any value with which the behaviors of various algorithms are controlled, and is not limited to a mathematical meaning such as an argument of a function.

The data set 89 of the input data 881 including destination data 882 and data of corresponding profile 883 (profile information 15g) in the learning is input to the learning information model 15d. That is, the parameter of the learning information model 15d is determined based on the input destination and the profile corresponding to the destination. In other words, the parameter of the learning information model 15d is determined by “supervised learning” using the data set 89 as learning data.

The data set 89 is a data set in which data of a physical profile, a mental profile, a success point, and a satisfaction level are associated with a suggested destination. The data set is learning data of machine learning. Specifically, a data set of a success point with a valid value is treated as successful data and training data in machine learning. Data that has a high success point becomes higher successful data. The successful data may be ranked by combining the satisfaction level.

For example, the destinations in the first and second rows of FIG. 11 are both “destination A”, but the first row indicates failure data in which the success point is 0 and the second row indicates successful data in which the success point is 10. By accumulating the successful data and the failure data, the learning information model 15d can learn destination suggestions that have high success probabilities with respect to the profile information 15g of the user, and thus it is possible to improve the accuracy of the suggestion.

For example, if “preference” among the elements included in the profile is preference of history and “openness” indicating activeness is high in the factor of “personality”, a destination to a historical district such as a castle is preferred.

On the other hand, if “preference” of the user of the user terminal (main) is preference of history but openness is low in the “personality”, the destination to the history district may not be preferred, and if a grandchild is in the family member of the profile, it can be estimated that the user prefers the destination where there is an amusement park or a pool that the grandchild may prefer.

In the behavior suggestion system 7 according to the embodiment, the behavior suggestion device 10 analyzes a profile of a main user (an elderly person or the like) and also analyzes a profile of a sub-user who is a supporter (a child, a grandchild, or the like of the elderly person) of the main user (the elderly person or the like) and can suggest a destination, and the main user (the elderly person or the like) can easily accept the suggestion. This is because, even when the elderly person is not willing to go for outing, the elderly person may make behavior modification for outing when their child and grandchild accompanies, and thus a probability of accepting the suggestion increases.

The destination of the data set 89 is a destination/course suggested by the behavior suggestion device 10. The data of the profile 883 of the data set 89 is obtained by analyzing a questionnaire or IoT data and analyzing the profile of a target user. The profile 883 includes a physical profile of gender, height, family member, and the like and a mental profile of preference, personality, lifestyle, and the like. Each of the physical profile and the mental profile has a vector value indicating a parameter condition of the profile. Here, the vector value indicates a value of each element of gender, preference, and personality such as Big 5 by a matrix value or the like. The success point of the data set 89 is an accumulation of aggregation results of points given for the outing to the suggested destination (for example, data subjected to statistical processing). The satisfaction level of the data set 89 is an accumulation of the satisfaction levels calculated for the outing to the suggested destination (for example, data subjected to statistical processing).

For each piece of data 881 of the data set 89, behavior modification success determination and satisfaction level calculation are performed. Behavior modification determination processing (S42 in FIG. 5B and FIG. 8) is performed on each piece of data 881 of the data set 89, and the calculated success point is fed back to the learning information model 15d along with the calculated satisfaction level as a determination result.

Machine learning is performed by generating the learning information model 15d that learns a data set with a high success point as successful data (training data), and machine learning is performed on a vector value of profiling data of the data set 89 by a method such as SVM.

As a result of the machine learning, a destination that has many success points can be suggested to a user having a similar parameter condition indicated by the vector value of the profile, and an improvement in the success rate of the behavior modification by the suggested destination can be expected.

As such, in the behavior suggestion system 7 according to the present embodiment, the success point does not become a valid value and does not become successful data unless the movement is out of the living area, and thus it is possible to perform machine learning of the learning information model 15d with appropriate successful data. Accordingly, the accuracy of the outing suggestion can be improved.

The learning information model 15d is, for example, an SVM, but another model such as a regression model, a decision tree, a random forest, or a neural network or a machine learning model may be used.

As such, in the behavior suggestion system 7 according to the present disclosure, it is possible to appropriately evaluate (determine) behavior modification. By appropriately evaluating the behavior modification, an appropriate suggestion is possible from the viewpoint of promoting behavior modification such as a suggestion that is easily accepted or a suggestion that contributes to habituation.

In each of the above-described embodiments, “determining whether it is A” may be determining that it is A, determining that it is not A, or determining whether or not it is A.

Each program executed by each device of the behavior suggestion system 7 according to each of the above-described embodiments is recorded and provided on a computer-readable storage medium such as a CD-ROM, an FD, a CD-R, or a DVD as a file in an installable format or an executable format.

Each program executed by each device of the behavior suggestion system 7 according to each of the above-described embodiments may be stored on a computer connected to a network such as the Internet and may be downloaded and provided via the network. Each program executed by each device of the behavior suggestion system 7 according to each of the above-described embodiments may be provided or distributed via a network such as the Internet.

Each program executed by each device of the behavior suggestion system 7 according to each of the above-described embodiments may be incorporated in advance in a ROM or the like and provided.

In addition, a program executed by each device of the behavior suggestion system 7 according to each of the above-described embodiments has a module configuration including each functional unit described above, and as actual hardware, a processor such as a CPU reads the program from a memory such as a ROM or an HDD and executes the program so that each functional unit described above is loaded on a RAM of the memory, and each functional unit described above is generated on the RAM of the memory.

According to at least one of the above-described embodiment, it is possible to make suggestions appropriate for users such as elderly people to make their behavior modification such as going out or outing by car.

According to the present disclosure, it is possible to receive suggestions appropriate for users such as elderly people to make behavior modification such as going out or outing by car.

While certain embodiments have been described, these embodiments have been presented by way of example only, and are not intended to limit the scope of the disclosures. Indeed, the novel methods and systems described herein may be embodied in a variety of other forms; furthermore, various omissions, substitutions and changes in the form of the methods and systems described herein may be made without departing from the spirit of the disclosures. The accompanying claims and their equivalents are intended to cover such forms or modifications as would fall within the scope and spirit of the disclosures.

What is claimed is:

1. A behavior suggestion device comprising:
a processor; and
a memory having instructions that, when executed by the processor, cause the processor to perform operations comprising:
acquiring, in communication with a first information terminal used by a first user via a network, user information of the first user received by the first information terminal, the user information including living area information indicating a living area of the first user;
causing the memory to store destination candidate information including one or more destination candidates;
electing, from the destination candidate information, one or more destinations different from at least a geographical range indicated by the living area information, based on profiling information obtained by analyzing the user information of the first user; and
outputting, to the first information terminal, suggestion information for suggesting the selected destination to the first user by the first information terminal.

2. The behavior suggestion device according to claim 1, wherein
the operations include:
acquiring, in communication with a second information terminal used by a second user via the network, user information of the second user received by the second information terminal; and
selecting, from the destination candidate information, one or more destinations as the suggested destination different from a destination based on the profiling information of the first user, further based on profiling information obtained by analyzing the user information of the second user.

3. The behavior suggestion device according to claim 2, wherein
the operations include outputting, to the first information terminal, the suggestion information for suggesting the destination selected by the first user and the destination selected by the second user to the first user to be comparable with each other.

4. The behavior suggestion device according to claim 1, wherein
the operations further include:
further acquiring positional information indicating a position of the first information terminal in a route guidance to a destination based on suggestion information output to the first information terminal; and
determining whether the suggestion information is successful data for making a behavior modification of the first user, based on the positional information and the living area information.

5. The behavior suggestion device according to claim 2, wherein
the operations further include:
further acquiring positional information indicating a position of the first information terminal in a route guidance to a destination based on suggestion information output to the first information terminal; and
determining whether the suggestion information is successful data for making a behavior modification of the first user, based on the positional information and the living area information.

6. The behavior suggestion device according to claim 3, wherein
the operations further include:
further acquiring positional information indicating a position of the first information terminal in a route guidance to a destination based on suggestion information output to the first information terminal; and
determining whether the suggestion information is successful data for making a behavior modification of the first user, based on the positional information and the living area information.

7. The behavior suggestion device according to claim 4, wherein
the operations include determining that the suggestion information is the successful data when the route guidance to the destination based on the suggestion information starts in the first information terminal.

8. The behavior suggestion device according to claim 5, wherein
the operations include determining that the suggestion information is the successful data when the route guidance to the destination based on the suggestion information starts in the first information terminal.

9. The behavior suggestion device according to claim 6, wherein
the operations include determining that the suggestion information is the successful data when the route guidance to the destination based on the suggestion information starts in the first information terminal.

10. The behavior suggestion device according to claim 4, wherein
the operations include inputting the profiling information obtained by analyzing the user information to a learning information model in which a parameter is learned so that a destination corresponding to the input profiling information is output among one or more destinations included in the destination candidate information, and acquiring a destination output from the learning information model according to the input of the profiling information as a destination to be selected.

11. The behavior suggestion device according to claim 5, wherein
the operations include inputting the profiling information obtained by analyzing the user information to a learning information model in which a parameter is learned so that a destination corresponding to the input profiling information is output among one or more destinations included in the destination candidate information, and acquiring a destination output from the learning information model according to the input of the profiling information as a destination to be selected.

12. The behavior suggestion device according to claim 6, wherein
the operations include inputting the profiling information obtained by analyzing the user information to a learning information model in which a parameter is learned so that a destination corresponding to the input profiling information is output among one or more destinations included in the destination candidate information, and acquiring a destination output from the learning information model according to the input of the profiling information as a destination to be selected.

13. The behavior suggestion device according to claim 10, wherein
the operations further include learning the parameter of the learning information model by using the destination based on the suggestion information determined to be the successful data and the profiling information corresponding to the destination.

14. The behavior suggestion device according to claim 4, wherein
the operations further include calculating a satisfaction level of the first user with respect to the destination based on the suggestion information determined to be the successful data, and outputting the calculated satisfaction level to the first information terminal.

15. The behavior suggestion device according to claim 5, wherein
the operations further include calculating a satisfaction level of the first user with respect to the destination based on the suggestion information determined to be the successful data, and outputting the calculated satisfaction level to the first information terminal.

16. The behavior suggestion device according to claim 6, wherein
the operations further include calculating a satisfaction level of the first user with respect to the destination based on the suggestion information determined to be the successful data, and outputting the calculated satisfaction level to the first information terminal.

17. A behavior suggestion method that is performed by a behavior suggestion device communicating with a first information terminal used by a first user via a network, the method comprising:
acquiring user information of the first user received by the first information terminal, the user information including living area information indicating a living area of the first user;
storing destination candidate information including one or more destination candidates;
selecting, from the destination candidate information, one or more destinations different from at least a geographical range indicated by the living area information, based on profiling information obtained by analyzing the user information of the first user; and
outputting, to the first information terminal, suggestion information for suggesting the selected destination to the first user by the first information terminal.

18. The behavior suggestion method according to claim 17, wherein
the acquiring includes acquiring, in communication with a second information terminal used by a second user via the network, user information of the second user received by the second information terminal, and
the selecting includes selecting, from the destination candidate information, one or more destinations as the suggested destination different from a destination based on the profiling information of the first user, further based on profiling information obtained by analyzing the user information of the second user.

19. The behavior suggestion method according to claim 18, wherein
the outputting includes outputting, to the first information terminal, the suggestion information for suggesting the destination selected by the first user and the destination selected by the second user to the first user to be comparable with each other.

20. A behavior suggestion method that is performed by a first information terminal communicating with a behavior suggestion device that provides a suggestion service of a behavior destination via a network, the method comprising:
connecting to the suggestion service that suggests a behavior destination;
receiving user information of a first user who uses the first information terminal, the user information including living area information indicating a living area of the first user;
transmitting the received user information of the first user to the connected suggestion service;
acquiring, from the behavior suggestion device, suggestion information for suggesting, to the first user, one or more destinations different from at least a geographical range indicated by the living area information, the one or more destinations being selected from destination candidate information including one or more destination candidates based on profiling information obtained by analyzing the user information of the first user; and
presenting a destination based on the suggestion information to the first user.
